(19) United States
(12) Patent Application Publication
(10) Pub. No.: US 2024/0397845 A1
(43) Pub. Date: Dec. 5, 2024

(54) OUTDOOR LAWN CONDITIONING TOOLS

(71) Applicant: Milwaukee Electric Tool Corporation, Brookfield, WI (US)

(72) Inventors: Devlin Thyne, Milwaukee, WI (US); Keith Grider, Brookfield, WI (US); Michael Van Dyke, Wauwatosa, WI (US)

(21) Appl. No.: 18/679,700

(22) Filed: May 31, 2024

Related U.S. Application Data
(60) Provisional application No. 63/470,627, filed on Jun. 2, 2023.

(51) Int. Cl. A01B 45/02

(52) U.S. Cl. CPC A01B 45/023

(57) ABSTRACT

Lawn conditioning tools are provided. A lawn conditioning tool includes a housing including an electric motor, a work element, and a drive shaft extending between the electric motor and the work element. The work element includes at least one support plate, at least one wheel, one or more bars extending between the at least one support plate and the at least one wheel, and a plurality of extension members extending from the one or more bars. The work element is rotatably driven by the electric motor via the drive shaft.

### FIELD

The present disclosure relates generally to outdoor lawn conditioning tools.

### BACKGROUND

Lawn conditioning activities, such as dethatching and aerating, can be strenuous. For example, dethatching and aerating tools are typically manually operated, which requires laborious activity for an extended period of time and can be exhausting for the operator. Additionally, conventional motorized lawn conditioning tools include large, ride-on devices or attachments to large, ride-on devices, such as tractors. Accordingly, lawn conditioning tools for dethatching and aerating that are compact and reduce strain experienced by an operator during use are desired in the art and would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a lawn conditioning tool is provided. The lawn conditioning tool includes a housing including an electric motor, a work element, and a drive shaft extending between the electric motor and the work element. The work element includes at least one support plate, at least one wheel, one or more bars extending between the at least one support plate and the at least one wheel, and a plurality of extension members extending from the one or more bars. The work element is rotatably driven by the electric motor via the drive shaft.

In accordance with another embodiment, a lawn conditioning tool is provided. The lawn conditioning tool includes a drive shaft extending between a first end and a second end opposite the first end, a housing including an electric motor coupled to the first end of the drive shaft, and a work element. The work element includes a first plate and a second plate rotatably mounted to the second end of the drive shaft and a plurality of extension members coupled to one or both of the first plate and the second plate. The plurality of extension members extend radially outward from a central axis extending between the first plate and the second plate.

In accordance with yet another embodiment, a lawn conditioning tool is provided. The lawn conditioning tool includes a shaft extending between a first end and a second end, a handle coupled to the first end of the shaft, and a work element coupled to the second end of the shaft. The work element is configured to rotate relative to the shaft. The work element includes a first plate, a second plate opposite the first plate, an auger extending between the first plate and the second plate, and a plurality of extension members coupled to one or both of the first plate and the second plate and extending radially outward from the auger.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a perspective view of a lawn conditioning tool in accordance with embodiments of the present disclosure;

FIG. 2 is a perspective view of an attachment of the lawn conditioning tool of FIG. 1 in accordance with embodiments of the present disclosure;

FIG. 3 is a perspective view of an attachment of the lawn conditioning tool of FIG. 1 in accordance with embodiments of the present disclosure;

FIG. 4A is a perspective view of a first side of a lawn conditioning tool in accordance with embodiments of the present disclosure; and

FIG. 4B is a perspective view of a second side of the lawn conditioning tool of FIG. 4A in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes.” “including.” “has.” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, lawn conditioning tools, such as dethatching and aerating tools, may be powered to reduce user strain and exhaustion as the lawn conditioning tools are used for an extended period of time. The lawn conditioning tools may also be compact and modular such that the lawn conditioning tools may be easily stored. Moreover, such modular lawn conditioning tools may have attachments, such as dethatching and aerating attachments, that may be used interchangeably.

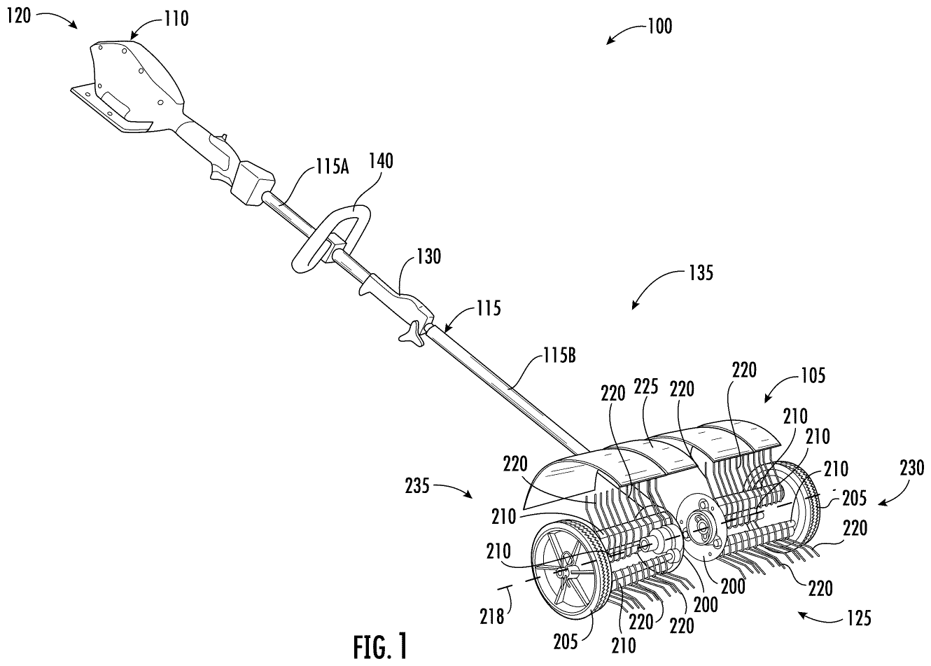

Referring now to the drawings, FIG. 1 illustrates a perspective view of a lawn conditioning tool 100 in accordance with embodiments of the present disclosure.

In at least one example embodiment, the lawn conditioning tool 100 includes a work element 105, a housing 110, and a drive shaft 115 extending between the work element 105 and the housing 110. The housing 110 may be at a first end 120 of the lawn conditioning tool 100 and the work element 105 may be at a second end 125 opposite the first end 120 of the lawn conditioning tool 100.

In at least one example embodiment, the drive shaft 115 is adjustable in length. For example, the drive shaft 115 may be telescopic, including one or more segments, such as a first shaft segment 115A and a second shaft segment 115B, that telescopically move relative to one another. For example, the first shaft segment 115A may be an outer shaft and the second shaft segment 115B may be an inner shaft. In other example embodiments, the second shaft segment 115B may be the outer shaft and first shaft segment 115A may be the inner shaft. The inner shaft may be configured to slide longitudinally within the outer pole between a retracted position and an extended position. An operator may adjust a distance between the work element 105 and the housing 110 by adjusting the relative positions of the first shaft segment 115A and the second shaft segment 115B with respect to one another. For example, the operator may move the one or both of the first shaft segment 115A and the second shaft segment 115B between the retracted position and the extended position. In at least one example embodiment, a lock or a clamp 130 may be used to maintain the first shaft segment 115A and the second shaft segment 115B at relatively fixed positions with respect to one another. For example, the clamp 130 may be actuatable between an unlocked position and a locked position such that the second shaft segment 115B is configured to slide longitudinally within the first shaft segment 115A in the unlocked position. Moreover, the first shaft segment 115A and the second shaft segment 115B are secured in a desired position when the clamp 130 is in the locked position.

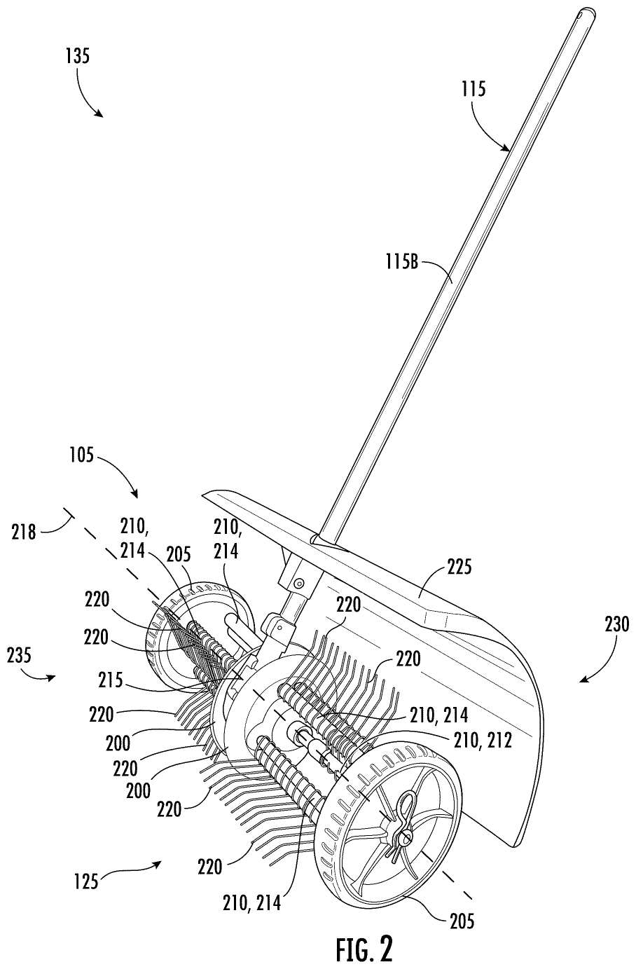

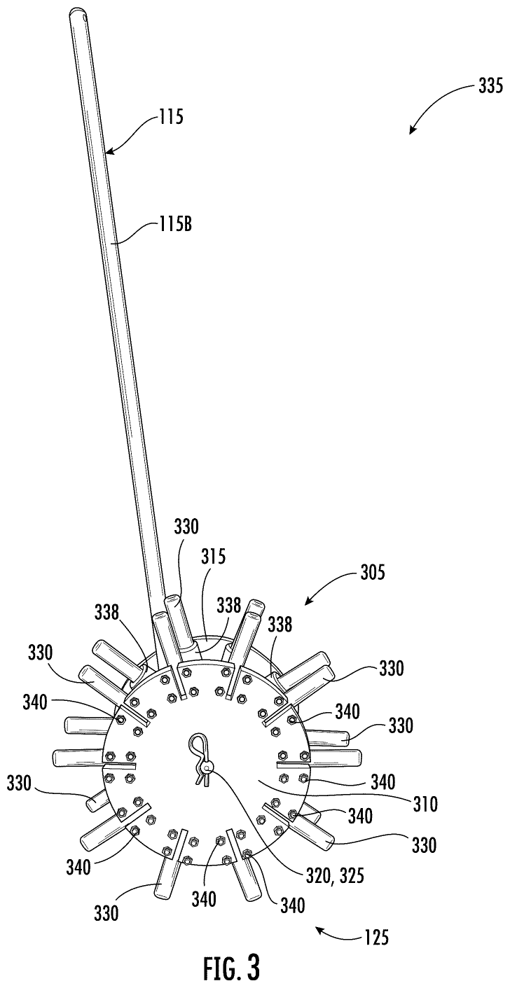

With reference to FIG. 2, which illustrates a perspective view of an attachment 135 of the lawn conditioning tool 100 of FIG. 1 in accordance with embodiments of the present disclosure, the second shaft segment 115B may be removable and replaceable. The attachment 135 may include the work element 105 and the second shaft segment 115B. In at least one example embodiment, the attachment 135 may be removed and replaced with another attachment having a different work element, as will be discussed with respect to FIG. 3, below. For example, the second shaft segment 115B may be removed from the first shaft segment 115A when the clamp 130 is actuated to the unlocked position and the attachment 135. The attachment 135 may be replaced or exchanged with a different attachment, such as that which will be discussed with respect to FIG. 3, and secured to the first shaft segment 115A by actuating the clamp 130 to the locked position. In other example embodiments, the attachment 135 includes the work element 105 such that the work element 105 may be removed from the second shaft segment 115B of the drive shaft 115 and replaced or interchanged with another work element. For example, clamp 130 may secure the second shaft segment 115B of the work element 105 to the first shaft segment 115A.

In at least one example embodiment, the work element 105 is a de-thatcher configured to loosen or remove thatch on the ground. As shown in FIGS. 1-2, the work element 105 includes at least one support plate 200, at least one wheel 205, and one or more bars 210 extending between the at least one support plate 200 and the at least one wheel 205. For example, the one or more bars 210 extend parallel with a central axis 218 extending through the at least one support plate 200 and the at least one wheel 205. The at least one support plate 200 may be rotatably mounted to the second end 125 of the drive shaft 115 or, more specifically, to the second end 125 of the second shaft segment 115B. For example, as shown in FIG. 2, the second shaft segment 115B may include a mount 215 at the second end for coupling the drive shaft 115 to the at least one support plate 200.

With reference to FIG. 2, the one or more bars 210 may include at least one auger 212 and one or more support bars 214. The at least one auger 212 may extend along the central axis 218 between the at least one support plate 200 and the at least one wheel 205, and the one or more support bars 214 may be radially spaced about the at least one auger 212 and the central axis 218. For example, the one or more support bars 214 may be equally spaced about the central axis 218. Moreover, the one or more support bars may be equally spaced about a circumference of the at least one support plate 200 and/or the at least one wheel 205. The at least one auger 212 may be configured to transmit rotational energy from the drive shaft 115 to the at least one support plate 200 and the at least one wheel 205. In other example embodiments, the at least one support plate 200 transmits rotational energy from the drive shaft 115 to the at least one wheel 205 via the one or more bars 210.

Additionally, the work element 105 includes a plurality of extension members 220 extending from the one or more bars 210. For example, the plurality of extension members 220 may extend from the plurality of support bars 214. The plurality of extension members 220 extend radially outward from the central axis 218. For example, the plurality of extension members 220 extend radially outward past the outer circumference of the at least one support plate 200 and the at least one wheel 205. The plurality of extension members 220 may include a plurality of blades or tines. In at least one example embodiment, the plurality of extension members 220 are equally spaced along a length of the one or more bars 210. In other example embodiments, the plurality of extension members 220 may be unequally spaced along the length of the one or more bars 210.

In at least one example embodiment, the lawn conditioning tool 100 includes a cover 225. The cover 225 may be configured to prevent debris and foreign objects from being expelled towards the operator of the lawn conditioning tool 100. The cover 225 may be coupled adjacent the second end 125 of the drive shaft 115. For example, the cover 225 may be coupled to the drive shaft 115 adjacent to the work element 105. The cover 225 may include a generally arcuate shape configured to cover at least a portion of the work element 105. For example, the cover 225 may extend from the drive shaft 115 towards a front side 230 of the work element 105 opposite a rear side 235 of the work element 104. Moreover, the cover 225 extends along a length of the work element 105. For example, the cover 225 extends perpendicular to the drive shaft 115. In at least one example embodiment, the cover 225 is a unitary body coupled to the drive shaft 115. In other example embodiments, such as shown in FIG. 1, the cover 225 may include two or more discrete members coupled to the drive shaft 115 and/or to each other for covering at least a portion of the work element 105.

With reference to FIG. 1, the lawn conditioning tool 100 may include a handle 140 coupled to at least a portion of the drive shaft 115. For example, the handle 140 may be coupled to the first shaft segment 115A adjacent the first end 120. Moreover, the handle 140 may be positioned between the housing 110 and the clamp 130.

In at least one example embodiment, the work element 105 is driven by a motor (not shown), such as an electric motor. For example, the motor may be housed in the housing 110. The drive shaft 115 is configured to transfer power from the motor to the work element 105. In other example embodiments, the motor may be housed within the work element 105 to drive rotation of the at least one support plate 200, the at least one wheel 205, and the one or more bars 210. The motor may receive electrical power from a power source (not shown). For example, the power source may be removably coupled to the housing 110. In at least one example embodiment, the power source includes one or more batteries.

FIG. 3 illustrates a perspective view of an attachment 335 of the lawn conditioning tool 100 of FIG. 1 in accordance with embodiments of the present disclosure. The attachment 335 may be similar to the attachment 135 discussed above with respect to FIGS. 1-2. More particularly, the attachment 335 may be interchangeable with or used in place of the attachment 135 of the lawn conditioning tool 100 discussed above with respect to FIGS. 1-2.

In at least one example embodiment, the attachment 335 includes the second shaft segment 115B and a work element 305. The work element 305 includes a first plate 310 and a second plate 315 rotatably mounted to the second end 125 of the drive shaft 115. More particularly, the first plate 310 and the second plate 315 are rotatably mounted to the second end 125 of the second shaft segment 115B. The second shaft segment 115B of the work element 305 may be removably coupled to the first shaft segment 115A, as discussed above with respect to FIGS. 1-2. Accordingly, the drive shaft 115 is configured to transfer power from the motor of the housing 110 to the work element 305 and drive rotation of the work element 305. For example, the drive shaft 115 is configured to drive rotation of the first plate 310 and the second plate 315. In some example embodiments, the work element 305 includes an auger 320 extending along a central axis 325 between the first plate 310 and the second plate 315. In such embodiments, the drive shaft 115 may be configured to drive rotation of the work element 305 via the auger 320. In other example embodiments, the motor may be housed in the work element 305 and configured to drive rotation of the first plate 310 and the second plate 315.

In at least one example embodiment, the work element 305 is an aerator configured to perforate the ground. For example, the work element 305 includes a plurality of extension members, such as a plurality of tubes 330, coupled to one or both of the first plate 310 and the second plate 315. The plurality of tubes 330 extend radially outward from an outer perimeter of the first plate 310 and the second plate 315. Moreover, the plurality of tubes 330 may be equally spaced about a circumference of the first plate 310 and the second plate 315. In other example embodiments, the plurality of tubes 330 may be unequally spaced about the circumference of the first plate 310 and the second plate 315.

In at least one example embodiment, the work element 305 may include a plurality of attachment members 338 for securing the plurality of tubes 330 to the interior surface of one or both of the first plate 310 and the second plate 315. As shown in FIG. 3, each of the plurality of attachment members 338 may surround at least a portion of each of the plurality of tubes 330. Additionally, the plurality of attachment members 338, and thereby the plurality of tubes 330, may be secured to one or both of the first plate 310 and the second plate 315 by a plurality of fasteners 340. The plurality of fasteners 340 may include screws, bolts, or any other means for securing the plurality of attachment members 338 to the first plate 310 and the second plate 315.

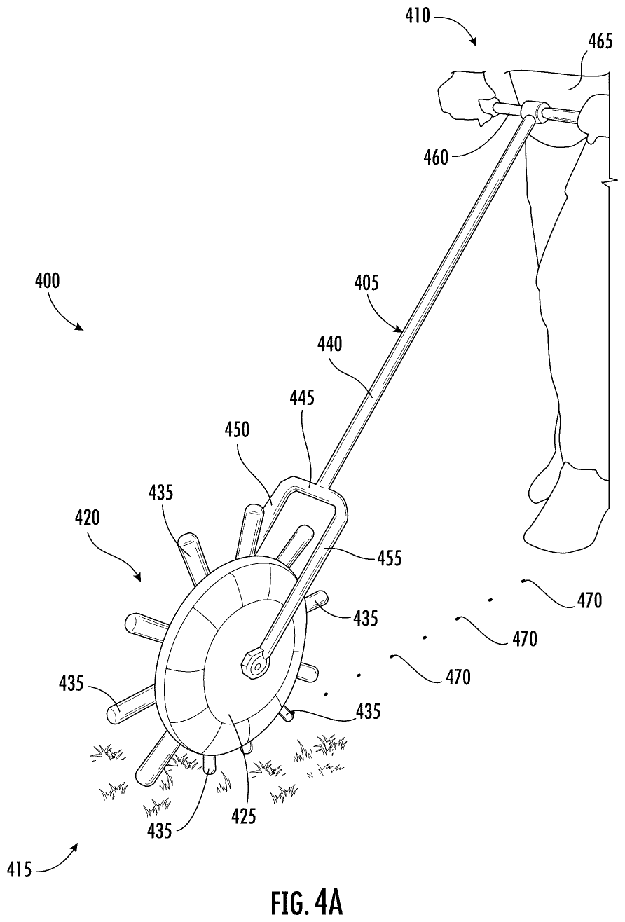

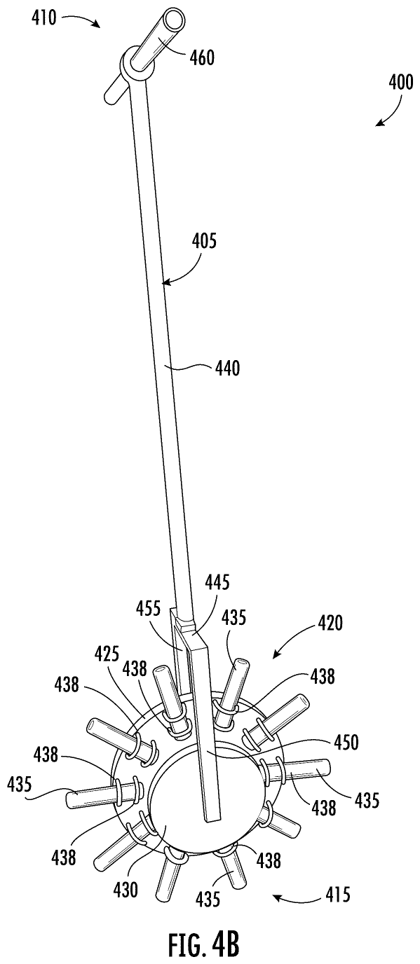

FIG. 4A illustrates a perspective view of a first side of a lawn conditioning tool 400 in accordance with embodiments of the present disclosure. FIG. 4B illustrates a perspective view of a second side of the lawn conditioning tool 400 of FIG. 4A in accordance with embodiments of the present disclosure.

The lawn conditioning tool 400 includes a shaft 405 extending between a first end 410 and a second end 415. The lawn conditioning tool 400 also includes a work element 420 coupled to the second end 415 of the shaft 405. In at least one example embodiment, such as shown in FIGS. 4A-4B, the work element 420 may include an aerator configured to perforate the ground.

The work element 420 may include a first plate 425, a second plate 430, and an auger (not shown) extending between the first plate 425 and the second plate 430. Additionally, the work element 420 includes a plurality of extension members, such as a plurality of tubes 435. As shown in FIGS. 4A-4B, the plurality of tubes 435 may be coupled to an interior surface of the first plate 425 and extend radially outward from an outer perimeter of the first plate 425. Additionally, as shown in FIG. 4B, the work element 420 may include a plurality of attachment members 438 for securing the plurality of tubes 435 to one or both of the first plate 425 and the second plate 430.

In other example embodiments, the plurality of tubes 435 may be coupled to the second plate 430 or both the first plate 425 and the second plate 430. In still other example embodiments, the work element 420 may include a plurality of one or both of the first plate 425 and the second plate 430 having the plurality of tubes 435 such that the work element includes two or more rows of the plurality of tubes 435 spaced in an axial direction, such as along the auger (not shown).

In at least one example embodiment, the shaft 405 includes a primary shaft segment 440 extending from the first end 410 towards the second end 415, a shaft base segment 445, a first shaft side segment 450, and a second shaft side segment 455. The shaft base segment 445 is coupled to the second end 415 of the primary shaft segment 440 and extends perpendicular to the primary shaft segment 440. The first shaft side segment 450 and the second shaft side segment 455 extend from opposing ends of the shaft base segment 445 towards the second end 415. Accordingly, the first shaft side segment 450 and the second shaft side segment 455 extend perpendicular to the shaft base segment 445. Additionally, the first shaft side segment 450 and the second shaft side segment 455 extend parallel to the primary shaft segment 440.

The work element 420 is configured to be rotatably coupled to ends of the first shaft side segment 450 and the second shaft side segment 455 opposite the shaft base segment 445. For example, the ends of the first shaft side segment 450 and the second shaft side segment 455 may be rotatably coupled to an exterior surface of the second plate 430 and an exterior surface of the first plate 425, respectively. More particularly, the ends of the first shaft side segment 450 and the second shaft side segment 455 may be rotatably coupled to opposing ends of the auger (not shown).

Additionally, the shaft 405 includes a handle 460 coupled to the first end 410 of the primary shaft segment 440. The handle 460 extends perpendicular to the primary shaft segment 440. As shown in FIG. 4A, the handle 460 may be gripped by an operator 465 during use of the lawn conditioning tool 400.

In operation, the operator 465 grips the handle 460 of the shaft 405 and drives the lawn conditioning tool forward and/or rearward. As the operator 465 drives the lawn conditioning tool 400 forward, the work element 420 rotates in a counter-clockwise direction, and as the operator 465 drives the lawn conditioning tool 400 rearwards, the work element 420 rotates in a clockwise direction. In the illustrated example shown in FIG. 4A, the operator 465 has driven the lawn conditioning tool 400 forward such that the work element 420 has rotated in the counter-clockwise direction. As the work element 420 rotates, the plurality of tubes 435 may penetrate the ground and form a plurality of perforations or holes 470.

Further aspects of the invention are provided by one or more of the following embodiments:

A lawn conditioning tool, comprising: a housing including an electric motor; a work element comprising: at least one support plate, at least one wheel, one or more bars extending between the at least one support plate and the at least one wheel, and a plurality of extension members extending from the one or more bars; and a drive shaft extending between the electric motor and the work element, wherein the work element is rotatably driven by the electric motor via the drive shaft.

The lawn conditioning tool of any one or more of the embodiments, wherein the drive shaft comprises a first shaft segment extending from the electric motor and a second shaft segment extending from the work element, and wherein the second shaft segment is removably receivable within the first shaft segment.

The lawn conditioning tool of any one or more of the embodiments, further comprising a clamp coupled to the drive shaft, wherein the clamp is actuatable between an unlocked position and a locked position, wherein the second shaft segment is configured to slide longitudinally within the first shaft segment, and wherein the first shaft segment and the second shaft segment are secured in a desired position when the clamp is in the locked position.

The lawn conditioning tool of any one or more of the embodiments, further comprising a handle extending from the first shaft segment of the drive shaft.

The lawn conditioning tool of any one or more of the embodiments, wherein the work element further comprises a cover coupled to the drive shaft and covering the work element, the cover extending perpendicular to the drive shaft.

The lawn conditioning tool of any one or more of the embodiments, further comprising a power source disposed in the housing and configured to supply power to the electric motor to drive the work element.

The lawn conditioning tool of any one or more of the embodiments, wherein the power source is removably coupled to the housing.

The lawn conditioning tool of any one or more of the embodiments, where the one or more bars are spaced circumferentially about a central axis extending between the at least one support plate and the at least one wheel.

The lawn conditioning tool of any one or more of the embodiments, wherein the plurality of extension members comprise a plurality of blades.

The lawn conditioning tool of any one or more of the embodiments, wherein the plurality of extension members comprise a plurality of tines.

The lawn conditioning tool of any one or more of the embodiments, wherein the plurality of extension members comprise a plurality of tubes.

A lawn conditioning tool, comprising: a drive shaft extending between a first end and a second end opposite the first end; a housing including an electric motor coupled to the first end of the drive shaft; and a work element comprising: a first plate and a second plate rotatably mounted to the second end of the drive shaft, and a plurality of extension members coupled to one or both of the first plate and the second plate, the plurality of extension members extending radially outward from a central axis extending between the first plate and the second plate.

The lawn conditioning tool of any one or more of the embodiments, wherein the drive shaft comprises a first shaft segment extending from the electric motor and a second shaft segment extending from the work element, and wherein the second shaft segment is removably receivable within the first shaft segment.

The lawn conditioning tool of any one or more of the embodiments, further comprising a clamp coupled to the drive shaft, wherein the clamp is actuatable between an unlocked position and a locked position, wherein the second shaft segment is configured to slide longitudinally within the first shaft segment, and wherein the first shaft segment and the second shaft segment are secured in a desired position when the clamp is in the locked position.

The lawn conditioning tool of any one or more of the embodiments, further comprising a handle extending from the first shaft segment of the drive shaft.

The lawn conditioning tool of any one or more of the embodiments, further comprising: a power source disposed in the housing and configured to supply power to the electric motor to drive the work element; wherein the power source is removably coupled to the housing.

The lawn conditioning tool of any one or more of the embodiments, wherein: the plurality of extension members comprise a first plurality of extension members and a second plurality of extension members; the first plurality of extension members are coupled to an interior surface of the first plate; and the second plurality of extension members are coupled to an interior surface of the second plate.

The lawn conditioning tool of any one or more of the embodiments, wherein the plurality of extension members comprise a plurality of tubes.

A lawn conditioning tool, comprising: a shaft extending between a first end and a second end; a handle coupled to the first end of the shaft; and a work element coupled to the second end of the shaft and configured to rotate relative to the shaft, the work element comprising: a first plate, a second plate opposite the first plate, an auger extending between the first plate and the second plate, and a plurality of extension members coupled to one or both of the first plate and the second plate and extending radially outward from the auger.

The lawn conditioning tool of any one or more of the embodiments, wherein the plurality of extension members comprise a plurality of tubes.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A lawn conditioning tool, comprising:
a housing including an electric motor;
a work element comprising:
at least one support plate,
at least one wheel,
one or more bars extending between the at least one support plate and the at least one wheel, and
a plurality of extension members extending from the one or more bars; and
a drive shaft extending between the electric motor and the work element, wherein the work element is rotatably driven by the electric motor via the drive shaft.

2. The lawn conditioning tool of claim 1, wherein the drive shaft comprises a first shaft segment extending from the electric motor and a second shaft segment extending from the work element, and wherein the second shaft segment is removably receivable within the first shaft segment.

3. The lawn conditioning tool of claim 2, further comprising a clamp coupled to the drive shaft, wherein the clamp is actuatable between an unlocked position and a locked position, wherein the second shaft segment is configured to slide longitudinally within the first shaft segment, and wherein the first shaft segment and the second shaft segment are secured in a desired position when the clamp is in the locked position.

4. The lawn conditioning tool of claim 2, further comprising a handle extending from the first shaft segment of the drive shaft.

5. The lawn conditioning tool of claim 1, wherein the work element further comprises a cover coupled to the drive shaft and covering the work element, the cover extending perpendicular to the drive shaft.

6. The lawn conditioning tool of claim 1, further comprising a power source disposed in the housing and configured to supply power to the electric motor to drive the work element.

7. The lawn conditioning tool of claim 6, wherein the power source is removably coupled to the housing.

8. The lawn conditioning tool of claim 1, where the one or more bars are spaced circumferentially about a central axis extending between the at least one support plate and the at least one wheel.

9. The lawn conditioning tool of claim 1, wherein the plurality of extension members comprise a plurality of blades.

10. The lawn conditioning tool of claim 1, wherein the plurality of extension members comprise a plurality of tines.

11. The lawn conditioning tool of claim 1, wherein the plurality of extension members comprise a plurality of tubes.

12. A lawn conditioning tool, comprising:
a drive shaft extending between a first end and a second end opposite the first end;
a housing including an electric motor coupled to the first end of the drive shaft; and
a work element comprising:
a first plate and a second plate rotatably mounted to the second end of the drive shaft, and
a plurality of extension members coupled to one or both of the first plate and the second plate, the plurality of extension members extending radially outward from a central axis extending between the first plate and the second plate.

13. The lawn conditioning tool of claim 12, wherein the drive shaft comprises a first shaft segment extending from the electric motor and a second shaft segment extending from the work element, and wherein the second shaft segment is removably receivable within the first shaft segment.

14. The lawn conditioning tool of claim 13, further comprising a clamp coupled to the drive shaft, wherein the clamp is actuatable between an unlocked position and a locked position, wherein the second shaft segment is configured to slide longitudinally within the first shaft segment, and wherein the first shaft segment and the second shaft segment are secured in a desired position when the clamp is in the locked position.

15. The lawn conditioning tool of claim 13, further comprising a handle extending from the first shaft segment of the drive shaft.

16. The lawn conditioning tool of claim 12, further comprising:
a power source disposed in the housing and configured to supply power to the electric motor to drive the work element;
wherein the power source is removably coupled to the housing.

17. The lawn conditioning tool of claim 12, wherein:
the plurality of extension members comprise a first plurality of extension members and a second plurality of extension members;
the first plurality of extension members are coupled to an interior surface of the first plate; and
the second plurality of extension members are coupled to an interior surface of the second plate.

18. The lawn conditioning tool of claim 12, wherein the plurality of extension members comprise a plurality of tubes.

19. A lawn conditioning tool, comprising:
a shaft extending between a first end and a second end;
a handle coupled to the first end of the shaft; and
a work element coupled to the second end of the shaft and configured to rotate relative to the shaft, the work element comprising:
a first plate,
a second plate opposite the first plate,
an auger extending between the first plate and the second plate, and
a plurality of extension members coupled to one or both of the first plate and the second plate and extending radially outward from the auger.

20. The lawn conditioning tool of claim 19, wherein the plurality of extension members comprise a plurality of tubes.
